(19) United States
(12) Patent Application Publication
(10) Pub. No.: US 2020/0332154 A1
(43) Pub. Date: Oct. 22, 2020

(54) MULTI-LAYERED THERMALLY CONDUCTIVE SHEET

(71) Applicant: 3M INNOVATIVE PROPERTIES COMPANY, St. Paul, MN (US)

(72) Inventors: Taehoon Noh, Gyeonggi-do (KR); Mihee Lee, GyungsangBuk-Do (KR); Jiwoong Kong, Gyeonggi-do (KR)

(21) Appl. No.: 16/768,936

(22) PCT Filed: Dec. 17, 2018
(86) PCT No.: PCT/IB2018/060197

§ 371 Date: Jun. 2, 2020

Related U.S. Application Data
(60) Provisional application No. 62/608,818, filed on Dec. 21, 2017.

(51) Int. Cl. C09J 7/38; C09K 5/14; C09J 11/04; C09J 7/25; H01M 10/655; B32B 27/30; B32B 27/40; B32B 27/08; B32B 27/20; B32B 27/22

(52) U.S. Cl. CPC C09J 7/385; B32B 2264/107; C09J 11/04; C09J 7/25; H01M 10/655; B32B 27/308; B32B 27/40; B32B 27/08; B32B 27/20; B32B 27/22; C09J 2205/114; C09J 2205/102; C09J 2433/00; C09J 2475/006; C09J 2203/33; B32B 2307/302; B32B 2457/10; B32B 2264/102; C09K 5/14

(57) ABSTRACT

Multi-layer thermally conductive sheets include at least two layers, a core layer and a surface layer. The core layer and the surface layer are simultaneously cured to form a multi-layer sheet where the core layer is tacky, and the surface layer is non-tacky. In some embodiments, the core layer is relatively soft. In other embodiments, the core layer is relatively hard.

### FIELD OF THE DISCLOSURE

The current disclosure relates to multi-layered thermally conductive sheets and devices prepared with them.

### BACKGROUND

Thermally conductive sheets are sheets that are used to join heat generating electronic elements and heat sinks and are well known as a method for cooling heating elements such as semiconductor elements installed in electronic devices. With the ongoing miniaturization and high integration of electronics, requirements for a thermally conductive sheets have been increasing. For example, the heat generating density of heating elements have increased because of higher integration and reduced size of electronic devices, and the thermal conductive sheets not only have to efficiently conduct heat away from the electronic elements, they have additional requirements such as long term stability when used at the high temperatures generated in recent electronic devices.

Examples of recent thermally conductive sheets include PCT Publication No. WO 2012/151101 (Tamura et al.) which describes a heat conductive sheet that maintains high heat conductivity and flexibility for long periods of time even in high temperature environments. In U.S. Pat. No. 7,709,098 (Yoda et al.) a multi-layered thermally conductive sheet having superior thermal conductivity and flame-retardency as well as superior handleability and adhesion.

### SUMMARY

This disclosure relates to multi-layer thermally conductive sheets, methods of preparing multi-layer thermally conductive sheets, and articles containing the multi-layer thermally conductive sheets.

The multi-layer thermally conductive sheets of this disclosure include at least two layers, a core layer and a surface layer. In some embodiments of the multi-layer thermally conductive sheets of this disclosure, the core layer is relatively soft. In these embodiments, the multi-layer thermally conductive sheet comprises a cured multi-layer curable construction, where the curable construction comprises a core layer which is tacky upon curing, and a surface layer which is non-tacky upon curing. The core layer comprises at least two (meth)acrylate monomers, a first (meth)acrylate monomer with a number average molecular weight greater than 200 grams/mole and a second (meth)acrylate monomer, at least one crosslinking monomer, at least one initiator, and thermally conductive filler, and may optionally include at least one plasticizer. The surface layer comprises at least one urethane-acrylate monomer, may optionally include at least one alkyl (meth)acrylate monomer, and at least one initiator.

In other embodiments of the multi-layer thermally conductive sheet, the core layer is relatively hard. In these embodiments, the multi-layer thermally conductive sheet comprises a cured multi-layer curable construction, where the curable construction comprises a core layer which is tacky upon curing, and a surface layer which is non-tacky upon curing. The core layer comprises at least one (meth)acrylate monomer with a number average molecular weight less than 200 grams/mole, at least one crosslinking monomer, at least one initiator, thermally conductive filler, and may optionally include at least one plasticizer. The surface layer comprises at least one urethane-acrylate monomer, may optionally include at least one alkyl (meth)acrylate monomer, and at least one initiator.

Also disclosed are methods of preparing multi-layer thermally conductive sheets. In some embodiments, the method of preparing a multi-layer thermally conductive sheet comprises preparing a first curable composition, preparing a second curable composition, providing a first carrier layer, providing a second carrier layer, contacting the second curable composition to the second carrier layer to form a second curable layer with a thickness of from 0.01-0.10 millimeters, contacting the first curable composition to the first carrier layer to form a first curable layer with a thickness of from 0.2-10.0 millimeters, contacting the second curable layer to the first curable layer, and simultaneously cure the first curable layer and the second curable layer to form a multi-layer thermally conductive sheet with a first cured layer that is tacky and a second cured layer that is non-tacky. The first curable composition comprises at least one (meth)acrylate monomer, at least one crosslinking monomer, at least one initiator, thermally conductive filler, and optionally at least one plasticizer. The second curable composition comprises at least one urethane-acrylate monomer, optionally at least one alkyl (meth)acrylate monomer, and at least one initiator.

Also disclosed are articles that contain the multi-layer thermally conductive sheets of this disclosure. In some embodiments, the article comprises a battery module with an exterior surface, a multi-layer thermally conductive sheet with a first surface and a second surface, and a metallic part with an exterior surface. The first surface of the multi-layer thermally conductive sheet is in contact with at least a portion of the exterior surface of the battery module and at least a portion of the exterior surface of the metallic part is in contact with the second surface of the thermally conductive sheet. The second surface of the multi-layer thermally conductive sheet is a tacky surface and the first surface of the multi-layer thermally conductive sheet is a non-tacky surface.

### BRIEF DESCRIPTION OF THE DRAWINGS

The present application may be more completely understood in consideration of the following detailed description of various embodiments of the disclosure in connection with the accompanying drawings.

FIG. 1 shows a cross-sectional view of an embodiment of a first curable composition layer of this disclosure.

FIG. 2 shows a cross-sectional view of an embodiment of a second curable composition layer of this disclosure.

FIG. 3 shows a cross-sectional view of a multi-layer curable article that upon curing forms the multi-layer thermally conductive sheet of this disclosure.

FIG. 4 shows a cross-sectional view of a device that utilizes a multi-layer thermally conductive sheet of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Thermally conductive sheets are sheets that are used to join heat generating electronic elements and heat sinks, such as metal parts, and are well known as a method for cooling heating elements such as semiconductor elements installed in electronic devices. With the ongoing miniaturization and high integration of electronics, requirements for thermally conductive sheets have been increasing. For example, the heat generating density of heating elements have increased because of higher integration and reduced size of electronic devices, and the thermally conductive sheets not only have to efficiently conduct heat away from the electronic elements, they have additional requirements such as long term stability when used at the high temperatures generated in recent electronic devices.

Additionally, adhesion of the thermally conductive sheets to the heat generating electronic elements and heat sinks can be important parameters, as well. Therefore, thermally conductive sheets often have some adhesive properties, such as tackiness, to aid them in forming strong surface contact with the heat generating electronic elements and heat sinks. However, as with any parameter, there is a trade off when the thermally conductive sheet adheres strongly to a surface. This trade off relates to the ease in removing one or more of the adhered surfaces from the thermally conductive sheets. One term used to describe this concept is handleability, and it relates to the ability to assemble a heat sink/thermally conductive sheet/heat generating electronic element construction and disassemble the construction if the elements are misaligned or there is some other issue with the assembled construction. This is particularly the case when the elements involved get larger and the corresponding adhesive forces grow larger as well. In some devices, it is desirable that the thermally conductive sheet have tackiness and adhere strongly to the heat sink surface, but not have tackiness on the surface that contacts the heat generating electronic element. There can be a wide range of reasons for this. Among the reasons one might wish to have a non-tacky surface on a thermally conductive sheet include handleability as described above, and also because electronic elements may be somewhat fragile and having a thermally conductive sheet strongly adhered to them may be detrimental.

One way to overcome the detrimental features of thermally conductive sheets is to use multi-layered articles. In this way, sheets with different properties can be used to give different properties. For example, one can laminate a highly tacky layer to a less tacky layer to produce a thermally conductive sheet with different levels of tack on the two major surfaces of the thermally conductive sheet to permit different levels of adhesion to the two major surfaces. In this way, strong adhesion to the heat sink surface can be effected without having strong adhesion to the heat generating electronic element. However, the use of multi-layered thermally conductive sheets have issues as well. Whenever multiple layers are used, the interfaces can disrupt the thermal conduction of the multi-layer article and make the articles insulators instead of conductors. Additionally, interfaces of laminated layers can be structurally unsound and can delaminate upon the application of stresses such as shear stresses.

Disclosed herein are multi-layer thermally conductive sheets that overcome the issues described above. The multilayer thermally conductive sheets have one major surface that is highly tacky and one major surface that has low tack or is non-tacky. The multi-layer thermally conductive sheets are not prepared by lamination, rather they are prepared in a single curing step. In the multilayer thermally conductive sheets, there is some transfer of thermally conductive filler across the interface to increase the conductivity of the non-tacky surface. The multi-layered thermally conductive sheets of this disclosure have superior thermal conductivity and flame retardancy as well as superior handleability and adhesion with an object on which the sheet is disposed.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

As used herein, the term “adjacent” refers to two layers that are proximate to another layer. Layers that are adjacent may be in direct contact with each other, or there may be an intervening layer. There is no empty space between layers that are adjacent.

The terms “Tg” and “glass transition temperature” are used interchangeably. If measured, Tg values are determined by Differential Scanning calorimetry (DSC) at a scan rate of 10° C./minute, unless otherwise indicated. Typically, Tg values for copolymers are not measured but are calculated using the well-known Fox Equation, using the monomer Tg values provided by the monomer supplier, as is understood by one of skill in the art.

The terms “room temperature” and “ambient temperature” are used interchangeably and have their conventional meaning, that is to say refer to temperature of 20-25° C.

The term “organic” as used herein to refer to a cured layer, means that the layer is prepared from organic materials and is free of inorganic materials.

The term “(meth)acrylate” refers to monomeric acrylic or methacrylic esters of alcohols. Acrylate and methacrylate monomers or oligomers are referred to collectively herein as “(meth)acrylates”. The term “(meth)acrylate-based” as used herein refers to a polymeric composition that comprises at least one (meth)acrylate monomer and may contain additional (meth)acrylate or non-(meth)acrylate co-polymerizable ethylenically unsaturated monomers. Polymers that are (meth)acrylate based comprise a majority (that is to say greater than 50% by weight) of (meth)acrylate monomers.

The terms “free radically polymerizable” and “ethylenically unsaturated” are used interchangeably and refer to a reactive group which contains a carbon-carbon double bond which is able to be polymerized via a free radical polymerization mechanism.

The term “hydrocarbon group” as used herein refers to any monovalent group that contains primarily or exclusively carbon and hydrogen atoms. Alkyl and aryl groups are examples of hydrocarbon groups.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

Disclosed herein are multi-layer thermally conductive sheets that have one major surface that is highly tacky and one major surface that has low tack or is non-tacky. The multi-layer thermally conductive sheets are not prepared by lamination, rather they are prepared in a single curing step. In the multilayer thermally conductive sheets, some transfer of thermally conductive filler across the interface increases the conductivity of the non-tacky surface. The multi-layered thermally conductive sheets of this disclosure have superior thermal conductivity and flame retardancy as well as superior handleability and adhesion with an object on which the sheet is disposed.

Disclosed herein are two embodiments of multi-layer thermally conductive sheets that have similar properties but are prepared from different but similar curable compositions. Each of these embodiments is provided in detail below. The embodiments include a first curable composition layer and a second curable composition layer. Upon curing the first curable composition layer produces what is called a core layer, and the second curable composition layer forms what is called the surface layer.

Two different embodiments of the first curable composition layer are given below, the first embodiment yielding a core layer upon curing that is relatively soft, with the second embodiment of the first curable composition layer yielding a core layer upon curing that is relatively hard. As used herein the embodiments of the multi-layer thermally conductive sheets that are described as having relatively soft core layers have a Shore OO hardness of less than 65, whereas those multi-layer thermally conductive sheets that are described as having relatively hard core layers have a Shore OO hardness of greater than 65.

The core layers, whether relatively soft or hard are tacky layers having a Probe Tack of at least 50 grams. The surface layer is essentially the same for each embodiment of the core layer, the surface layer being a low tack layer having a Probe Tack of no more than 5 grams.

Disclosed herein are methods of preparing multi-layer thermally conductive sheets that do not include lamination of cured layers, the methods comprising preparing a first curable composition, preparing a second curable composition, providing a first carrier layer and a second carrier layer, contacting the second curable composition to the second carrier layer to form a second curable layer with a thickness of from 0.01-0.10 millimeters, in some embodiments from 0.01-0.03 millimeters, contacting the first curable composition to the first carrier layer to form a first curable layer with a thickness of from 1.0-10.0 millimeters, in some embodiments from 1.0-2.0 millimeters, contacting the second curable layer to the first curable layer, and simultaneously cure the first curable layer and the second curable layer to form a multi-layer thermally conductive sheet with a first cured layer that is tacky and a second cured layer that is non-tacky.

The first curable composition comprises at least one (meth)acrylate monomer, at least one crosslinking monomer, at least one initiator, thermally conductive filler, and optionally at least one plasticizer.

A wide range of (meth)acrylate monomers are suitable for use in the first curable composition. Combinations of (meth)acrylate monomers are also suitable. This disclosure includes two different but similar first curable compositions. Each of these embodiments of the first curable composition is presented in detail below.

In a first embodiment of the first curable composition, an embodiment which produces a core layer that is relatively soft, the composition comprises at least two (meth)acrylate monomers, a first (meth)acrylate monomer with a number average molecular weight greater than 200 grams/mole and a second (meth)acrylate monomer. In some embodiments of the first embodiment of the first curable composition, the composition further comprises at least one of an alkyl (meth)acrylate monomer with a number average molecular weight of less than 200 grams/mole, and a reinforcing co-polymerizable monomer.

The second embodiment of the first curable composition comprises at least one (meth)acrylate monomer with a number average molecular weight less than 200 grams/mole. The monomers suitable for each of these embodiments are described below.

A wide range of first (meth)acrylate monomers with a number average molecular weight greater than 200 grams/mole are suitable. Examples of suitable first (meth)acrylate monomers include alkyl and aryl (meth)acrylate esters with the general formula I

H₂C═CR¹—(CO)—O—R² Formula I

Where R¹ is a hydrogen atom or a methyl group, and R² is a substituted or unsubstituted alkyl, aryl, aralkyl, or alkaryl group with at least 9 carbon atoms. In some embodiments, R² has at least 10 carbon atoms. In some particularly suitable embodiments, R² is a linear or branched alkyl group with at least 10 carbon atoms. Examples of suitable (meth)acrylate monomers include lauryl acrylate, n-decyl acrylate, isodecyl acrylate, isodecyl methacrylate, isostrearyl acrylate, isobornyl acrylate, and isononyl (meth)acrylate. One particularly suitable monomer is lauryl acrylate.

The first embodiment of the first curable composition comprises a second (meth)acrylate monomer in addition to the first (meth)acrylate monomer. This second (meth)acrylate monomer, unlike the first (meth)acrylate monomer, is not limited to a specific molecular weight. Typically this monomer, like the first (meth)acrylate monomer comprises a (meth)acrylate monomer with a relatively high molecular weight. In many embodiments this monomer also has a molecular weight of at least 200 grams/mole, or even greater than 300 grams/mole. Examples of suitable (meth)acrylate monomers include the same monomers listed above. One particularly suitable second (meth)acrylate monomer is isostrearyl acrylate.

In some embodiments, of the first embodiment of the first curable composition, the composition further comprises at least one of an alkyl (meth)acrylate monomer with a number average molecular weight of less than 200 grams/mole, and a reinforcing co-polymerizable monomer.

A wide range of alkyl (meth)acrylate monomers with a number average molecular weight of less than 200 grams/mole are suitable. These monomers are also described by Formula I above, but the group R² can be any substituted or unsubstituted alkyl group with from 1-9 carbon atoms. Particularly suitable alkyl (meth)acrylate monomers with a number average molecular weight of less than 200 grams/mole include 2-methylbutyl acrylate, isooctyl acrylate, 4-methyl-2-pentyl acrylate, isoamyl acrylate, sec-butyl acrylate, n-butyl acrylate, n-hexyl acrylate, 2-ethylhexyl acrylate, and n-octyl acrylate.

A wide range of copolymerizable reinforcing monomers are suitable. The reinforcing monomer has a homopolymer glass transition temperature (Tg) higher than that of the alkyl (meth)acrylate monomer and is one that increases the glass transition temperature and cohesive strength of the resultant copolymer. Generally, the reinforcing monomer has a homopolymer Tg of at least about 10° C. Suitable examples of reinforcing (meth)acrylic monomers, include acrylic acid, methacrylic acid, an acrylamide, or a (meth)acrylate with such a Tg. Examples include, but are not limited to, acrylamides, such as acrylamide, methacrylamide, N-methyl acrylamide, N-ethyl acrylamide, N-hydroxyethyl acrylamide, diacetone acrylamide, N,N-dimethyl acrylamide, N, N-diethyl acrylamide, N-ethyl-N-aminoethyl acrylamide, N-ethyl-N-hydroxyethyl acrylamide, N,N-dihydroxyethyl acrylamide, t-butyl acrylamide, N,N-dimethylaminoethyl acrylamide, and N-octyl acrylamide. Other examples include itaconic acid, crotonic acid, maleic acid, fumaric acid, 2,2-(diethoxy)ethyl acrylate, 2-hydroxyethyl acrylate or methacrylate, 3-hydroxypropyl acrylate or methacrylate, methyl methacrylate, isobornyl acrylate, 2-(phenoxy)ethyl acrylate or methacrylate, biphenylyl acrylate, t-butylphenyl acrylate, cyclohexyl acrylate, dimethyladamantyl acrylate, 2-naphthyl acrylate, phenyl acrylate, N-vinyl formamide, N-vinyl acetamide, N-vinyl pyrrolidone, and N-vinyl caprolactam. Particularly suitable reinforcing acrylic monomers include acrylic acid and acrylamide.

A wide range in the relative amounts of the above described monomers is suitable in the first curable composition. Typically, the first curable composition comprises a majority of the first (meth)acrylate monomers with a number average molecular weight greater than 200 grams/mole. By this it is meant that the first (meth)acrylate monomer is present in an amount of greater than 50% by weight.

The first curable composition also comprises at least one crosslinking agent that is co-polymerizable with the monomers described above. One class of useful crosslinking agents are multifunctional (meth)acrylate species. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

The crosslinking agent is used in an effective amount, by which is meant an amount that is sufficient to cause crosslinking of the first curable composition to provide adequate cohesive strength to produce the desired final adhesion properties to the substrate of interest. Generally, the crosslinking agent is used in an amount of about 0.1 to about 10 weight %, based on the total weight of monomers.

The first curable composition also comprises at least one initiator. Initiators are compounds that upon activation generate free radicals to initiate the free radical polymerization of the free radically polymerizable components in the curable composition. Typically the initiator is a photoinitiator, meaning that the initiator is activated by light, generally ultraviolet (UV) light, although other light sources could be used with the appropriate choice of intiator, such a visible light initiators, infrared light initiators, and the like. Thus the curable compositions are generally curable by UV or visible light, typically UV light. Therefore, typically, UV photoinitiators are used as the initiator. Photoinitiators are well understood by one of skill in the art of (meth)acrylate polymerization. Examples of suitable free radical photoinitiators include IRGACURE 4265, IRGACURE 184, IRGACURE 651, IRGACURE 1173, IRGACURE 819, IRGACURE TPO, IRGACURE TPO-L, commercially available from BASF, Charlotte, N.C.

Generally the photoinitiator is used in amounts of 0.01 to 10 parts by weight, more typically 0.1 to 2.0, parts by weight relative to 100 parts by weight of total reactive components.

Besides the reactive species described above, the first curable composition can also comprise non-reactive materials. Typically the first curable composition comprises at least one thermally conductive filler, and at least one plasticizer. Additional optional non-reactive materials may also be added such as flame retardants, antioxidants, dispersants, flow control agents, and the like.

Examples of suitable thermally conductive fillers include one or more kinds selected from the group consisting of metallic oxides, metallic nitrides, and metallic carbides. Examples of the metallic oxide include aluminum oxide, magnesium oxide, beryllium oxide, titanium oxide, zirconium oxide, and zinc oxide. Examples of the metallic nitrides include boron nitride, aluminum nitride, and silicon nitride. Examples of the metallic carbides include boron carbide, aluminum carbide, and silicon carbide. Among these, particularly suitable fillers are aluminum oxide, magnesium oxide, boron nitride, aluminum nitride, and silicon carbide from the viewpoint of thermal conductivity and mechanical properties.

Plasticizers are additives that increase the plasticity or viscosity of a material. Typically these materials are liquids with low volatility. They decrease the attraction between polymer chains to make them more flexible. A wide range of the plasticizers are suitable including dicarboxylic/tricarboxylic ester-based plasticizers, trimellitates, adipates, sebacates, and maleates. Phthalates can also be used, but these materials are not the most desirable since they are being phased out in some locales due to health concerns. Among the particularly suitable plasticizers is diisononyl adipate (DINA).

In some embodiments it may be desirable to add a flame retardant additive. Suitable flame retardants are metal hydrate flame retardants. Examples of a metal hydrates useful in the multi-layered thermally conductive sheets of the present disclosure include aluminum hydroxide, magnesium hydroxide, barium hydroxide, calcium hydroxide, dawsonite, hydrotalcite, zinc borate, calcium aluminate, and zirconium oxide hydrate. Mixtures of these metal hydrates may also be used. Among these, aluminum hydroxide and magnesium hydroxide are particular suitable from the viewpoint of the effect on flame retardancy. Generally, these metal hydrates are added to the material in the form of particles and the metal hydrate may have been subjected to a surface treatment with silane, titanate, fatty acid, or the like, so as to enhance strength (for example, tensile/breaking strength) of the resultant multi-layered thermally conductive sheet.

The first curable composition may also include one or more antioxidants. A variety of antioxidants are suitable, including phenolics, quinolones, phosphites, and benzimidazoles. Examples of commercially available suitable antioxidants are the IRGANOX family of phenolic antioxidants commercially available from BASF, such as IRGANOX 1010 and IRGANOX 1076. One particularly suitable antioxidant is IRGANOX 1010.

Regardless of the chemical composition of the first curable composition layer, it typically comprises 10-20% by weight of reactive components. By this it is meant that the total of the reactive components comprises 10-20% by weight of the total weight of the first curable composition layer.

The second embodiment of the first curable composition, as was mentioned above, when cured forms a core layer that is relatively harder than the first embodiment of the first curable composition. Many of the components of the second embodiment of the first curable composition are the same or similar to some of the components described above. The second embodiment of first curable composition layer of this disclosure comprises at least one (meth)acrylate monomer with a number average molecular weight less than 200 grams/mole, at least one crosslinking monomer, at least one initiator, thermally conductive filler, and at least one plasticizer. As with the first embodiment of the first curable composition layer described above, the second embodiment of the first curable composition layer may also comprise additional optional elements.

The second embodiment of the first curable composition comprises at least one (meth)acrylate monomer with a number average molecular weight less than 200 grams/mole. A wide range of (meth)acrylate monomers with a number average molecular weight of less than 200 grams/mole are suitable. These monomers are also described by Formula I above, but the group R² can be any substituted or unsubstituted alkyl group with from 1-9 carbon atoms. Particularly suitable alkyl (meth)acrylate monomers with a number average molecular weight of less than 200 grams/mole include 2-methylbutyl acrylate, isooctyl acrylate, 4-methyl-2-pentyl acrylate, isoamyl acrylate, sec-butyl acrylate, n-butyl acrylate, n-hexyl acrylate, 2-ethylhexyl acrylate, and n-octyl acrylate.

The first curable composition also comprises at least one crosslinking agent that is co-polymerizable with the monomers described above. One class of useful crosslinking agents are multifunctional (meth)acrylate species. Multifunctional (meth)acrylates include tri(meth)acrylates and di(meth)acrylates (that is, compounds comprising three or two (meth)acrylate groups). Typically di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

In some embodiments, the second embodiment of the first curable composition further comprises a copolymerizable reinforcing monomer. A wide range of copolymerizable reinforcing monomers are suitable. The reinforcing monomer has a homopolymer glass transition temperature (Tg) higher than that of the alkyl (meth)acrylate monomer and is one that increases the glass transition temperature and cohesive strength of the resultant copolymer. Generally, the reinforcing monomer has a homopolymer Tg of at least about 10° C. Suitable examples of reinforcing (meth)acrylic monomers, include acrylic acid, methacrylic acid, an acrylamide, or a (meth)acrylate with such a Tg. Examples include, but are not limited to, acrylamides, such as acrylamide, methacrylamide, N-methyl acrylamide, N-ethyl acrylamide, N-hydroxyethyl acrylamide, diacetone acrylamide, N,N-dimethyl acrylamide, N, N-diethyl acrylamide, N-ethyl-N-aminoethyl acrylamide, N-ethyl-N-hydroxyethyl acrylamide, N,N-dihydroxyethyl acrylamide, t-butyl acrylamide, N,N-dimethylaminoethyl acrylamide, and N-octyl acrylamide. Other examples include itaconic acid, crotonic acid, maleic acid, fumaric acid, 2,2-(diethoxy)ethyl acrylate, 2-hydroxyethyl acrylate or methacrylate, 3-hydroxypropyl acrylate or methacrylate, methyl methacrylate, isobornyl acrylate, 2-(phenoxy)ethyl acrylate or methacrylate, biphenylyl acrylate, t-butylphenyl acrylate, cyclohexyl acrylate, dimethyladamantyl acrylate, 2-naphthyl acrylate, phenyl acrylate, N-vinyl formamide, N-vinyl acetamide, N-vinyl pyrrolidone, and N-vinyl caprolactam. Particularly suitable reinforcing acrylic monomers include acrylic acid and acrylamide.

As mentioned above, the first curable composition also comprises at least one initiator. Initiators are compounds that upon activation generate free radicals to initiate the free radical polymerization of the free radically polymerizable components in the curable composition. Typically the initiator is a photoinitiator, meaning that the initiator is activated by light, generally ultraviolet (UV) light, although other light sources could be used with the appropriate choice of intiator, such a visible light initiators, infrared light initiators, and the like. Thus the curable compositions are generally curable by UV or visible light, typically UV light. Therefore, typically, UV photoinitiators are used as the initiator. Photoinitiators are well understood by one of skill in the art of (meth)acrylate polymerization. Examples of suitable free radical photoinitiators include IRGACURE 4265, IRGACURE 184, IRGACURE 651, IRGACURE 1173, IRGACURE 819, IRGACURE TPO, IRGACURE TPO-L, commercially available from BASF, Charlotte, N.C.

Generally the photoinitiator is used in amounts of 0.01 to 10 parts by weight, more typically 0.1 to 2.0, parts by weight relative to 100 parts by weight of total reactive components.

It should be noted that the second embodiment of the first curable composition layer also comprises non-reactive materials as well such as thermally conductive filler, and optionally at least one plasticizer. Each of these materials is described above. In addition, the second embodiment of the first curable composition layer may include additional optional non-reactive materials, as are described above. In some embodiments, the second embodiment of the first curable composition layer includes a flow control agent. A wide variety of flow control agents are suitable, one particularly suitable flow control agent is silica.

Regardless of the chemical composition of the first curable composition layer, it typically comprises 10-20% by weight of reactive components. By this it is meant that the total of the reactive components comprises 10-20% by weight of the total weight of the first curable composition layer. In some embodiments of the second embodiment of the first curable composition layer, the amount of thermally conductive filler comprises 30-90% by weight of the total weight of the first curable composition layer.

The method of the present disclosure includes a second curable composition layer which is co-curable with the first curable composition layer described above. The second curable composition comprises at least one urethane-acrylate monomer, optionally at least one alkyl (meth)acrylate monomer, and at least one initiator.

A wide range of urethane-acrylate monomers are suitable. Urethane-acrylate monomers are materials that comprise urethane resins that are functionalized with (meth)acrylate groups. A wide variety of materials are commercially available from suppliers such as Sartomer and Shin Nakamura Chemical. In some embodiments the urethane-acrylate monomer is a polyester urethane-acrylate, meaning that the urethane resin portion contains polyester linkages. These linkages can be formed, for example, by using polyester polyols to form the urethane resin. Examples of commercially available urethane-acrylate monomers include those available from Shin Nakamura Chemical as UA-122P, UA-160TM, U-15HA, UA-1100H, U-6LPA. An example of a particularly suitable urethane-acrylate monomer is the polyester-based urethane-acrylate monomer with a functionality of two, commercially available from Shin Nakamura Chemical as UA-122P.

A wide range of alkyl (meth)acrylates are suitable. Examples of suitable alkyl (meth)acrylate monomers include alkyl (meth)acrylate esters with the general formula I:

H₂C═CR¹—(CO)—O—R² Formula I

Where R¹ is a hydrogen atom or a methyl group, and R² is a substituted or unsubstituted alkyl group with from 1-12 carbon atoms. Examples of suitable (meth)acrylate monomers include 2-methylbutyl acrylate, isooctyl acrylate, 4-methyl-2-pentyl acrylate, isoamyl acrylate, sec-butyl acrylate, n-butyl acrylate, n-hexyl acrylate, 2-ethylhexyl acrylate, and n-octyl acrylate, lauryl acrylate, n-decyl acrylate, isodecyl acrylate, isodecyl methacrylate, isostrearyl acrylate, isobornyl acrylate, and isononyl (meth)acrylate. One particularly suitable monomer is 2-ethylhexyl acrylate.

The second curable composition also comprises at least one initiator. Initiators are compounds that upon activation generate free radicals to initiate the free radical polymerization of the free radically polymerizable components in the curable composition. Typically the initiator is a photoinitiator, meaning that the initiator is activated by light, generally ultraviolet (UV) light, although other light sources could be used with the appropriate choice of intiator, such a visible light initiators, infrared light initiators, and the like. Thus the curable compositions are generally curable by UV or visible light, typically UV light. Therefore, typically, UV photoinitiators are used as the initiator. Photoinitiators are well understood by one of skill in the art of (meth)acrylate polymerization. Examples of suitable free radical photoinitiators include IRGACURE 4265, IRGACURE 184, IRGACURE 651, IRGACURE 1173, IRGACURE 819, IRGACURE TPO, IRGACURE TPO-L, commercially available from BASF, Charlotte, N.C. The same initiator used for the first curable composition layer can be used or a different initiator may be used in the second curable composition layer.

Generally the photoinitiator is used in amounts of 0.01 to 10 parts by weight, more typically 0.1 to 2.0, parts by weight relative to 100 parts by weight of total reactive components.

Besides the reactive species described above, the second curable composition can also comprise optional non-reactive materials. Examples of optional additives include thermally conductive fillers, plasticizers, flame retardants, antioxidants, dispersants, flow control agents, and the like. Each of these non-reactive materials is described above.

The method of simultaneous curing of the two curable layers is dependent upon the initiators chosen for incorporation into the two curable layers. In most embodiments, the initiators are photoinitiators that are activated by UV light. In some embodiments, the photoinitiators are the same in the two curable layers. To activate these photoinitiators, the curable layers are exposed to UV light provided for example by a UV lamp. The amount of time required to effect curing will depend upon a variety of factors such as the choice of photoinitiators, the concentration of photoinitiators, the thickness of the samples, and so forth as is well understood by one of skill in the art.

Regardless of the chemical composition of the first curable composition layer, it typically comprises 10-20% by weight of reactive components. By this it is meant that the total of the reactive components comprises 10-20% by weight of the total weight of the first curable composition layer.

The choice of curable materials present in the curable reaction mixtures, particularly the choice of curable materials selected for the first curable reaction mixture, effects the properties of the cured thermally conductive sheet. For example, when the first curable composition layer comprises the first embodiment of the first curable composition layer, the thermally conductive sheet has a Shore OO hardness of less than 65. These embodiments, as mentioned above, are referred to as being relatively soft. In other embodiments, the thermally conductive sheet has a Shore OO hardness of greater than 65. Typically, these thermally conductive sheets are ones that include first curable compositions described above as the second embodiment of the first curable composition, and these embodiments are described as being relatively hard.

Besides the above listed hardness values, the cured thermally conductive sheets have a wide range of desirable properties such as thermal conductivity and flame retardancy as well as superior handleability and adhesion with an object on which the sheet is disposed. In some embodiments, the thermally conductive sheet has a thermal conductivity of at least 0.50 Watts/meter K.

Also disclosed herein are multi-layer thermally conductive sheets prepared by the methods described above. The cured multi-layer thermally conductive sheets prepared using a first curable composition layer described above as the first embodiment of the first curable composition layer, is a multi-layer construction with a core layer which is tacky upon curing and a surface layer which is non-tacky upon curing. The core layer composition is the cured layer comprising the first curable composition layer described above as the first embodiment of the first curable composition layer, with at least two (meth)acrylate monomers, a first (meth)acrylate monomer with a number average molecular weight greater than 200 grams/mole and a second (meth)acrylate monomer, at least one crosslinking monomer, at least one initiator, thermally conductive filler, and optionally at least one plasticizer. The surface layer, which is non-tacky upon curing, is the cured layer comprising the second curable composition layer, with at least one urethane-acrylate monomer, optionally at least one alkyl (meth)acrylate monomer, and at least one initiator.

As described above, in some embodiments, the core layer which is tacky upon curing, further comprises at least one of an alkyl (meth)acrylate monomer with a number average molecular weight of less than 200 grams/mole, and a reinforcing co-polymerizable monomer. Examples of suitable alkyl (meth)acrylate monomers and reinforcing co-polymerizable monomers are described above.

The surface layer, which is non-tacky upon curing, is the cured layer comprising the second curable composition layer, in some embodiments comprises a urethane-acrylate monomer that contains polyester groups.

Also as described above, the first embodiment of the first curable composition layer, which upon curing forms the core layer, contains both reactive and non-reactive components. Thus the core layer, upon curing contains, besides the cured matrix, thermally conductive filler, optionally at least one plasticizer, and optional additional additives such as flame retardant agents, and the like as described above. The ratio of reactive components to non-reactive can vary widely. In some embodiments the first embodiment of the first curable composition layer comprises 10-20% by weight of curable components.

The core layer formed from the first embodiment of the first curable layer is relatively soft, giving the thermally conductive sheet a Shore OO hardness of less than 65. Shore OO hardness and how it is measured is described in the Examples section.

The multi-layer thermally conductive sheets of this disclosure can have a wide range of thickness. Typically, the core layer thickness is from 0.2-10.0 millimeters and the surface layer thickness is from 0.01-0.10 millimeters. The core layer which is tacky upon curing typically has a Probe Tack of at least 50 grams and the surface layer which is non-tacky upon curing has a Probe Tack of no greater than 5 grams. The thermally conductive sheet with a core layer formed from the first embodiment of the first curable composition layer has a thermal conductivity of at least 0.50 Watts/meter K.

Also disclosed herein are multi-layer thermally conductive sheets where the cured multi-layer thermally conductive sheets prepared using a first curable composition layer described above as the second embodiment of the first curable composition layer, is a multi-layer construction with a core layer which is tacky upon curing and a surface layer which is non-tacky upon curing. The core layer composition is the cured layer comprising the first curable composition layer described above as the second embodiment of the first curable composition layer, with at least one (meth)acrylate monomer with a number average molecular weight less than 200 grams/mole, at least one crosslinking monomer, at least one initiator, thermally conductive filler, and optionally at least one plasticizer. The surface layer, which is non-tacky upon curing, is the cured layer comprising the second curable composition layer, with at least one urethane-acrylate monomer, optionally at least one alkyl (meth)acrylate monomer, and at least one initiator.

As described above, in some embodiments, the core layer formed from the second embodiment of the first curable composition layer may further comprise a reinforcing co-polymerizable monomer. Examples of suitable reinforcing co-polymerizable monomers are described above.

The surface layer, which is non-tacky upon curing, is the cured layer comprising the second curable composition layer, in some embodiments comprises a urethane-acrylate monomer that contains polyester groups.

Also as described above, the second embodiment of the first curable composition layer, which upon curing forms the core layer, contains both reactive and non-reactive components. Thus the core layer, upon curing contains, besides the cured matrix, thermally conductive filler, at least one plasticizer, and optional additional additives such as flame retardant agents, and the like as described above. The ratio of reactive components to non-reactive can vary widely. In some embodiments the first embodiment of the first curable composition layer comprises 10-20% by weight of curable components.

The core layer formed from the second embodiment of the first curable layer is relatively hard, giving the thermally conductive sheet a Shore OO hardness of greater than 65. Shore OO hardness and how it is measured is described in the Examples section.

The multi-layer thermally conductive sheets of this disclosure can have a wide range of thicknesses. Typically, the core layer thickness is from 0.2-10.0 millimeters and the surface layer thickness is from 0.01-0.10 millimeters. The core layer which is tacky upon curing typically has a Probe Tack of at least 50 grams and the surface layer which is non-tacky upon curing has a Probe Tack of no greater than 5 grams. The thermally conductive sheet with a core layer formed from the first embodiment of the first curable composition layer has a thermal conductivity of at least 0.50 Watts/meter K.

In addition to the multi-layer thermally conductive sheets disclosed above, articles are also disclosed that utilize these multi-layer thermally conductive sheets. A wide variety of articles in which generated heat is desirably channeled to a metallic part or other heat sink are suitable for use with the multi-layer thermally conductive sheets of this disclosure. Among the suitable articles are batteries for electric cars. The batteries can generate heat that is desirably channeled to a metallic part or other heat sink by the multi-layer thermally conductive sheets of this disclosure.

One embodiment of an article comprises a battery module with an exterior surface, a multi-layer thermally conductive sheet with a first surface and a second surface, wherein the first surface of the multi-layer thermally conductive sheet is in contact with at least a portion of the exterior surface of the battery module, and a metallic part with an exterior surface, where at least a portion of the exterior surface of the metallic part is in contact with the second surface of the thermally conductive sheet. In these embodiments, the thermally conductive sheet comprises a multi-layer thermally conductive sheet as described above, wherein the second surface of the multi-layer thermally conductive sheet is a tacky surface and the first surface of the multi-layer thermally conductive sheet is a non-tacky surface.

The disclosure may be further understood in light of the figures. FIG. 1 is a cross sectional view of an embodiment of a first curable composition layer, which upon curing forms the core layer. On first carrier layer 10 is disposed first curable composition layer 20. First curable composition layer 20 may comprise the first embodiment of the first curable composition layer or the second embodiment of the first curable composition layer as described above.

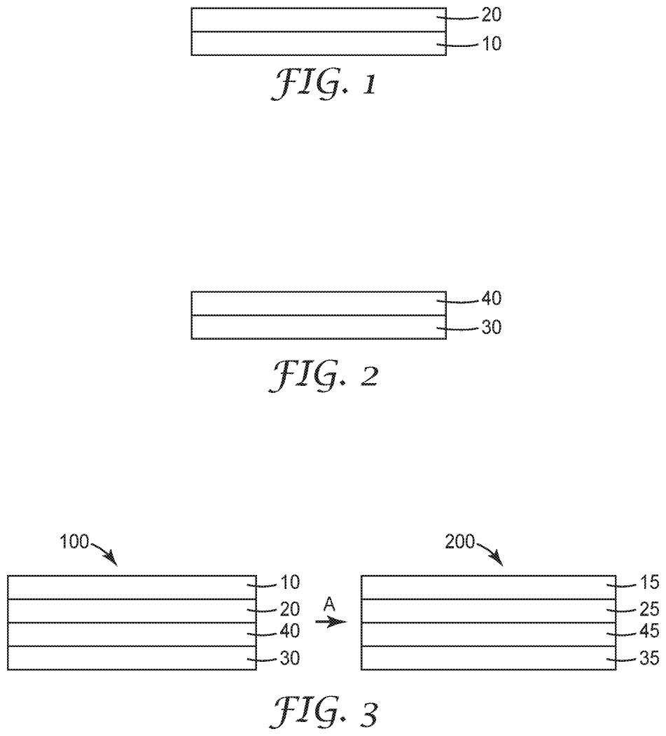

FIG. 2 shows a cross sectional view of an embodiment of a second curable composition layer, which upon curing forms the surface layer. On second carrier layer 30 is disposed second curable composition layer 40. The second curable composition layer is described above.

FIG. 3 shows an article where the articles of FIG. 1 and FIG. 2 are combined and then cured to form the multi-layer thermally conductive sheet of this disclosure. The articles of FIG. 1 and FIG. 2 are combined to form a curable multi-layer article 100 comprising first carrier layer 10, first curable composition layer 20, second curable composition layer 40, and second carrier layer 30. Article 100 is then cured by process step A, which typically is exposure to UV radiation, to generate thermally conductive sheet 200 comprising first carrier layer 15, the core layer (the cured first curable composition layer) 25, the surface layer (i.e. the cured second curable composition layer) 45, and second carrier layer 35.

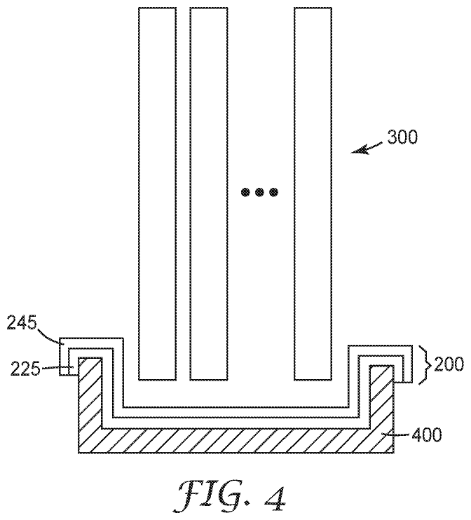

FIG. 4 shows a cross sectional view of an article that utilizes the multi-layer thermally conductive sheet of this disclosure. FIG. 4 shows heat generating article 300 which is a battery module, article 300 is in contact with conductive sheet 200 which has surface layer 245 and core layer 225. Core layer 225 is in contact with the surface of metallic part 400. The tackiness of core layer 225 helps to anchor it to the surface of metallic part 400. The non-tackiness of surface layer 245 helps to give handleability, in this case meaning that the battery module can easily be removed from contact with the surface layer 245 and repositioned.

This disclosure includes the following embodiments:

Among the embodiments are multi-layer thermally conductive sheets. Embodiment 1 includes a multi-layer thermally conductive sheet comprising: a cured multi-layer curable construction, the curable construction comprising: a core layer which is tacky upon curing comprising: at least two (meth)acrylate monomers, a first (meth)acrylate monomer with a number average molecular weight greater than 200 grams/mole and a second (meth)acrylate monomer; at least one crosslinking monomer; at least one initiator; and thermally conductive filler; and a surface layer which is non-tacky upon curing comprising: at least one urethane-acrylate monomer; and at least one initiator.

Embodiment 2 is the multi-layer thermally conductive sheet of embodiment 1, wherein the core layer which is tacky upon curing further comprises at least one of: an alkyl (meth)acrylate monomer with a number average molecular weight of less than 200 grams/mole; and a reinforcing co-polymerizable monomer; and at least one plasticizer.

Embodiment 3 is the multi-layer thermally conductive sheet of embodiment 1 or 2, wherein the surface layer which is non-tacky upon curing further comprises at least one of: an alkyl(meth)acrylate monomer; and a flow control agent.

Embodiment 4 is the multi-layer thermally conductive sheet of any of embodiments 1-3, wherein the core layer which is tacky upon curing comprises 30-90% by weight of thermally conductive filler.

Embodiment 5 is the multi-layer thermally conductive sheet of embodiment 4, wherein the thermally conductive filler is selected from one or more metal oxides, metallic nitrides, or metallic carbides.

Embodiment 6 is the multi-layer thermally conductive sheet of any of embodiments 1-5, wherein the core layer comprises 10-20% by weight of curable components.

Embodiment 7 is the multi-layer thermally conductive sheet of any of embodiments 1-6, wherein the conductive sheet has a Shore OO hardness of less than 65.

Embodiment 8 is the multi-layer thermally conductive sheet of any of embodiments 1-7, wherein the at least one urethane (meth)acrylate monomer contains polyester groups.

Embodiment 9 is the multi-layer thermally conductive sheet of any of embodiments 1-8, wherein the thermally conductive sheet has a thermal conductivity of at least 0.50 Watts/meter K.

Embodiment 10 is the multi-layer thermally conductive sheet of any of embodiments 1-9, wherein the core layer which is tacky upon curing has a Probe Tack of at least 50 grams and the surface layer which is non-tacky upon curing has a Probe Tack of no greater than 5 grams.

Embodiment 11 is the multi-layer thermally conductive sheet of any of embodiments 1-10, wherein the core layer thickness is from 0.2-10.0 millimeters and the surface layer thickness is from 0.01-0.10 millimeters.

Embodiment 12 is a multi-layer thermally conductive sheet comprising: a cured multi-layer curable construction, the curable construction comprising: a core layer which is tacky upon curing comprising: at least one (meth)acrylate monomer with a number average molecular weight less than 200 grams/mole; at least one crosslinking monomer; at least one initiator; thermally conductive filler; and at least one plasticizer; and a surface layer which is non-tacky upon curing comprising: at least one urethane-acrylate monomer; at least one alkyl (meth)acrylate monomer; and at least one initiator.

Embodiment 13 is the multi-layer thermally conductive sheet of embodiment 12, wherein the core layer which is tacky upon curing further comprises at least one reinforcing co-polymerizable monomer.

Embodiment 14 is the multi-layer thermally conductive sheet of embodiment 12 or 13, wherein the surface layer which is non-tacky upon curing further comprises at least one flow control agent.

Embodiment 15 is the multi-layer thermally conductive sheet of any of embodiments 12-14, wherein the core layer which is tacky upon curing comprises 30-90% by weight of thermally conductive filler.

Embodiment 16 is the multi-layer thermally conductive sheet of any of embodiments 12-15, wherein the core layer comprises 10-20% by weight of curable components.

Embodiment 17 is the multi-layer thermally conductive sheet of any of embodiments 12-16, wherein the thermally conductive sheet has a Shore OO hardness of greater than 65.

Embodiment 18 is the multi-layer thermally conductive sheet of any of embodiments 12-17, wherein the at least one urethane (meth)acrylate monomer contains polyester groups.

Embodiment 19 is the multi-layer thermally conductive sheet of any of embodiments 12-18, wherein the thermally conductive sheet has a thermal conductivity of at least 0.50 Watts/meter K.

Embodiment 20 is the multi-layer thermally conductive sheet of any of embodiments 12-19, wherein the core layer which is tacky upon curing has a Probe Tack of at least 50 grams and the surface layer which is non-tacky upon curing has a Probe Tack of no greater than 5 grams.

Embodiment 21 is the multi-layer thermally conductive sheet of any of embodiments 12-20, wherein the core layer thickness is from 0.2-10.0 millimeters and the surface layer thickness is from 0.01-0.10 millimeters.

Embodiment 22 is the multi-layer thermally conductive sheet of any of embodiments 12-21, wherein the core layer which is tacky upon curing comprises 30-90% by weight of thermally conductive filler.

Embodiment 23 is the multi-layer thermally conductive sheet of embodiment 22, wherein the thermally conductive filler is selected from one or more metal oxides, metallic nitrides, or metallic carbides.

Embodiment 24 is the multi-layer thermally conductive sheet of any of embodiments 12-23, wherein the core layer comprises 10-20% by weight of curable components.

Also disclosed are methods of preparing a multi-layer thermally conductive sheet. Embodiment 25 includes a method of preparing a multi-layer thermally conductive sheet comprising: preparing a first curable composition comprising: at least one (meth)acrylate monomer; at least one crosslinking monomer; at least one initiator; thermally conductive filler; and at least one plasticizer; preparing a second curable composition comprising: at least one urethane-acrylate monomer; at least one alkyl (meth)acrylate monomer; and at least one initiator; providing a first carrier layer; providing a second carrier layer; contacting the second curable composition to the second carrier layer to form a second curable layer with a thickness of from 0.01-0.10 millimeters; contacting the first curable composition to the first carrier layer to form a first curable layer with a thickness of from 0.2-10.0 millimeters; contacting the second curable layer to the first curable layer; and simultaneously cure the first curable layer and the second curable layer to form a multi-layer thermally conductive sheet with a first cured layer that is tacky and a second cured layer that is non-tacky.

Embodiment 26 is the method of embodiment 25, wherein the first curable composition comprises: at least two (meth)acrylate monomers, a first (meth)acrylate monomer with a number average molecular weight greater than 200 grams/mole and a second (meth)acrylate monomer; at least one crosslinking monomer; at least one initiator; thermally conductive filler; and at least one plasticizer.

Embodiment 27 is the method of embodiment 26, wherein the first curable composition further comprises at least one of: an alkyl (meth)acrylate monomer with a number average molecular weight of less than 200 grams/mole; and a reinforcing co-polymerizable monomer.

Embodiment 28 is the method of embodiment 25, wherein the (meth)acrylate monomer of the first curable composition comprises a (meth)acrylate monomer with a number average molecular weight less than 200 grams/mole.

Embodiment 29 is the method of any of embodiments 25-27, wherein the thermally conductive sheet has a Shore OO hardness of less than 65.

Embodiment 30 is the method of embodiment 25 or 28, wherein the thermally conductive sheet has a Shore OO hardness of greater than 65.

Embodiment 31 is the method of any of embodiments 25-30, wherein the thermally conductive sheet has a thermal conductivity of at least 0.50 Watts/meter K.

Also disclosed are articles. Embodiment 32 includes an article comprising: a battery module with an exterior surface; a multi-layer thermally conductive sheet with a first surface and a second surface, wherein the first surface of the multi-layer thermally conductive sheet is in contact with at least a portion of the exterior surface of the battery module; and a heat sink with an exterior surface, where at least a portion of the exterior surface of the heat sink is in contact with the second surface of the thermally conductive sheet; wherein the second surface of the multi-layer thermally conductive sheet is a tacky surface and the first surface of the multi-layer thermally conductive sheet is a non-tacky surface.

Embodiment 33 is the article of embodiment 32, wherein the multi-layer thermally conductive sheet comprises: a cured multi-layer curable construction, the curable construction comprising: a core layer which is tacky upon curing comprising: at least two (meth)acrylate monomers, a first (meth)acrylate monomer with a number average molecular weight greater than 200 grams/mole and a second (meth)acrylate monomer; at least one crosslinking monomer; at least one initiator; thermally conductive filler; and at least one plasticizer; and a surface layer which is non-tacky upon curing comprising: at least one urethane-acrylate monomer; at least one alkyl (meth)acrylate monomer; and at least one initiator.

Embodiment 34 is the article of embodiment 33, wherein the core layer which is tacky upon curing further comprises at least one of: an alkyl (meth)acrylate monomer with a number average molecular weight of less than 200 grams/mole; and a reinforcing co-polymerizable monomer.

Embodiment 35 is the article of embodiment 33 or 34, wherein the surface layer which is non-tacky upon curing further comprises at least one flow control agent.

Embodiment 36 is the article of any of embodiments 33-35, wherein the core layer which is tacky upon curing comprises 30-90% by weight of thermally conductive filler.

Embodiment 37 is the article of embodiment 36, wherein the thermally conductive filler is selected from one or more metal oxides, metallic nitrides, or metallic carbides.

Embodiment 38 is the article of any of embodiments 33-37, wherein the core layer comprises 10-20% by weight of curable components.

Embodiment 39 is the article of any of embodiments 33-38, wherein the conductive sheet has a Shore OO hardness of less than 65.

Embodiment 40 is the article of any of embodiments 33-39, wherein the at least one urethane (meth)acrylate monomer contains polyester groups.

Embodiment 41 is the article of any of embodiments 33-40, wherein the thermally conductive sheet has a thermal conductivity of at least 0.50 Watts/meter K.

Embodiment 42 is the article of any of embodiments 33-41, wherein the core layer which is tacky upon curing has a Probe Tack of at least 50 grams and the surface layer which is non-tacky upon curing has a Probe Tack of no greater than 5 grams.

Embodiment 43 is the article of any of embodiments 33-42, wherein the core layer thickness is from 0.2-10.0 millimeters and the surface layer thickness is from 0.01-0.10 millimeters.

Embodiment 44 is the article of embodiment 32, wherein the multi-layer thermally conductive sheet comprises: a cured multi-layer curable construction, the curable construction comprising: a core layer which is tacky upon curing comprising: at least one (meth)acrylate monomer with a number average molecular weight less than 200 grams/mole; at least one crosslinking monomer; at least one initiator; thermally conductive filler; and at least one plasticizer; and a surface layer which is non-tacky upon curing comprising: at least one urethane-acrylate monomer; at least one alkyl (meth)acrylate monomer; and at least one initiator.

Embodiment 45 is the article of embodiment 44, wherein the core layer which is tacky upon curing further comprises at least one reinforcing co-polymerizable monomer.

Embodiment 46 is the article of embodiment 44 or 45, wherein the surface layer which is non-tacky upon curing further comprises at least one flow control agent.

Embodiment 47 is the article of any of embodiments 44-46, wherein the core layer which is tacky upon curing comprises 30-90% by weight of thermally conductive filler.

Embodiment 48 is the article of any of embodiments 44-47, wherein the core layer comprises 10-20% by weight of curable components.

Embodiment 49 is the article of any of embodiments 44-48, wherein the thermally conductive sheet has a Shore OO hardness of greater than 65.

Embodiment 50 is the article of any of embodiments 44-49, wherein the at least one urethane (meth)acrylate monomer contains polyester groups.

Embodiment 51 is the article of any of embodiments 44-50, wherein the thermally conductive sheet has a thermal conductivity of at least 0.50 Watts/meter K.

Embodiment 52 is the article of any of embodiments 44-51, wherein the core layer which is tacky upon curing has a Probe Tack of at least 50 grams and the surface layer which is non-tacky upon curing has a Probe Tack of no greater than 5 grams.

Embodiment 53 is the article of any of embodiments 44-52, wherein the core layer thickness is from 0.2-10.0 millimeters and the surface layer thickness is from 0.01-0.10 millimeters.

Embodiment 54 is the article of any of embodiments 44-53, wherein the core layer which is tacky upon curing comprises 30-90% by weight of thermally conductive filler.

Embodiment 55 is the article of embodiment 54, wherein the thermally conductive filler is selected from one or more metal oxides, metallic nitrides, or metallic carbides.

Embodiment 56 is the article of any of embodiments 44-55, wherein the core layer comprises 10-20% by weight of curable components.

### EXAMPLES

Objects and advantages of this disclosure are further illustrated by the following comparative and illustrative examples. Unless otherwise noted, all parts, percentages, ratios, etc. in the examples and the rest of the specification are by weight, and all reagents used in the examples were obtained, or are available, from general chemical suppliers such as, for example, Sigma-Aldrich Corp., Saint Louis, Mo., US.

TABLE 1
Materials Used

| Material | Description | Source |
|---|---|---|
| 2-EHA | 2-ethyl hexyl acrylate | BASF |
| | monomer: T_{g} = −85° C., | |
| | MW = 184 g/mol | |
| Lauryl Acrylate | Monomer: T_{g} = 15° C., | BASF |
| | MW = 240 g/mol | |
| Isostearyl | Monomer: T_{g} = −18° C., | Osaka Organic Chemical |
| Acrylate | MW = 324 g/mol | Industry, Japan |
| AA | Acrylic Acid | BASF |
| HDDA | Hexanediol Diacrylate | Sartomer |
| UV | IRGACURE 651 | BASF, Florham Park, NJ |
| Photoinitiator-1 | | |
| UV | IRGACURE 819 | Ciba Specialty Chemicals |
| Phtotoinitiator-2 | | Corporation, Tarry town, |
| | | NY |
| DINA | Diisononyl Adipate | HB Chemical, |
| | Plasticizer | Twinsburg, OH |
| Antioxidant | IRGANOX 1010 | BASF, Florham Park, NJ |
| Dispersant | S-151 | Nippon Soda, Japan |
| Aluminum | Thermally Conductive | KC, Korea |
| Hydroxide | Filler | |
| Alumina | Thermally Conductive | KC, Korea |
| | Filler | |
| Urethane Acrylate | UA-122P | Shin-Nakamura |
| Monomer | | Chemicals, Wakayama, |
| | | Japan |
| Silica powder | AEROSIL R972 | EVONIK Corp., |
| | | Piscataway, NJ |
| BN Powder | Boron Nitride Powder, | 3M Company |
| | Thermally Conductive | |
| | Filler | |

### Core Layer

The formulation of the tacky core layer used to prepare Examples 1-6 and for Comparative Examples CE1-CE3 are provided in Tables 2 and 3. The components listed in the Tables 2 and 3 were placed in a high shear mixer and mixed for 1 hour and then degassed for 30 minutes at reduced pressure (0.01 MPa) to prepare the curable heat conductive composition. The curable heat conductive compositions were then sandwiched between two PET (polyethylene terephthalate) liners treated with a silicone release agent, and calendar molded into a sheet shape.

TABLE 2
Core Layer Formulation: Examples
1-4 and Comparative Example CE1

| Material | Amount (weight %) |
|---|---|
| 2-EHA | 11.53 |
| AA | 0.10 |
| HDDA | 0.02 |
| UV Photoinitiator-2 | 0.03 |
| DINA | 6.92 |
| Antioxidant | 0.23 |
| Dispersant | 0.46 |
| Aluminum Hydroxide | 80.70 |

TABLE 3
Core Layer Formulation for Ex 5-6, CE2-CE3

| Material | Ex. 5 | Ex. 6 | CE2 | CE3 |
|---|---|---|---|---|
| 2-EHA | | 100 | | 100 |
| Lauryl Acrylate | 55 | | 55 | |
| Isostearyl Acrylate | 35 | | 35 | |
| AA | 0.15 | 0.9 | 0.15 | 0.9 |
| HDDA | 0.2 | 0.2 | 0.2 | 0.2 |
| UV Photoinitiator-2 | 0.4 | 0.3 | 0.4 | 0.3 |
| DINA | 70 | 60 | 70 | 60 |
| Antioxidant | 2 | 2 | 2 | 2 |
| Dispersant | 2 | 4 | 2 | 4 |
| Aluminum Hydroxide | 500 | 700 | 500 | 700 |
| Alumina | 100 | | 100 | |
| Total Filler Ratio, wt % | 78.5 | 80.7 | 78.5 | 80.7 |

### Surface Layer

The compositions of the surface layers used for Examples 1-6 are provided in Table 4. The surface layer for Example 2 included BN powder to increase the thermal conductivity. The ratio of urethane acrylate to alkyl(meth)acrylate monomer in the surface layers of Examples 1-6 was varied. Comparative Examples CE1, CE2, and CE3 consisted only of a core layer and did not have a non-tacky surface layer. The components listed in the Table 4 were placed in a high shear mixer and mixed for 1 hour and then degassed for 30 minutes at reduced pressure (0.01 MPa) to prepare the curable heat conductive composition. The curable heat conductive compositions were then sandwiched between two PET (polyethylene terephthalate) liners treated with a silicone release agent, and calendar molded into a sheet shape.

TABLE 4
Surface Layer Formulation

| Material | Ex. 1 | Ex. 2 | Ex. 3 | Ex. 4 | Ex. 5 | Ex. 6 |
|---|---|---|---|---|---|---|
| Urethane Acrylate | 60 | 60 | 40 | 60 | 40 | 40 |
| 2-EHA | 90 | 90 | 80 | 60 | 60 | 60 |
| Silica Powder | 10.5 | 10 | 7 | 7 | 7 | 7 |
| BN Powder | 0 | 40 | 0 | 0 | 0 | 0 |
| UV Photoinitiator-1 | 0.18 | 0.18 | 0 | 0 | 0.12 | 0.12 |

### Production of Multilayer Thermally Conductive Sheet

The multilayered Examples 1-6 and single-layered Comparative Examples CE1-CE3 were prepared using the single-pass radiation curing process described above in the detailed description. For Examples 1-4 and CE1, the thickness of the thermally conductive core layer was 0.97 mm. For Examples 1-4, the thickness of the surface layer was 0.03 mm.

### Properties of Multilayer Thermally Conductive Sheet Examples

Tackiness of the Examples and Comparative Examples was measured using a probe tack tester PT-1000 (available from ChemInstruments, Ohio, US). For comparison, the tack of a typical PET film was measured as 0.436 g.

Thermal conductivity was measured based upon a modified transient plane source method by using a TCi Thermal Conductivity Analyzer (available from C-Therm Technologies, Canada).

Hardness was measured using a Shore OO Durometer GS-754G (TECLOK, Japan).

Results are summarized in Table 5. The tackiness of Examples 1-6, each of which included a surface layer, was similar to that of a conventional PET film (0.436 g). It can be concluded that the inclusion of the surface layer reduces tack sufficiently to allow for easy handling during the rework process. Thermal conductivity of Examples 1-6 was comparable to the Comparative Examples, and Example 2, which included BN powder, exhibited higher thermal conductivity than the Comparative Examples. Since the inclusion of a non-tacky surface layer increases the hardness of the multi-layer thermally conductive sheet relative to a single layer, tacky, thermally conductive sheet, the relatively low values of Shore OO hardness for the multi-layer thermally conductive sheets (Ex 5 and Ex 6) relative to the single sheet Comparative Examples CE2 and CE3 is surprising.

TABLE 5
Properties of Examples and Comparative Examples

| Property | Ex. 1 | Ex. 2 | Ex. 3 | Ex. 4 | Ex. 5 | Ex. 6 | CE1 | CE2 | CE3 |
|---|---|---|---|---|---|---|---|---|---|
| Tackiness (g) | 0.436 | 0.436 | 0.436 | 0.436 | 0.4 | 0.4 | 52.4 | 177 | N/A |
| Thermal conductivity (W/m · K) | 1.72 | 1.93 | 1.73 | 1.74 | 1.51 | 1.70 | 1.80 | 1.71 | 1.80 |
| Hardness (Shore OO) | N/A | N/A | N/A | N/A | 61 | 80 | N/A | 44 | 75 |

Scanning Electron Microscopy (SEM) micrographs of multilayered thermally conductive sheet Example 1 were taken (JSM-5600LV, JEOL, Japan). The micrographs showed no gap or delamination that could be discerned between the core layer and the surface layers. Additionally, some ceramic fillers were observed in the core layer, demonstrating some diffusion of material between the core and surface layers in the multilayered sheet.

FT-IR analysis was conducted (Thermo Nicolet, ThermoFisher)for the surface layer and the core layer. The surface layer demonstrated a peak around 1500 cm⁻¹, which was not observed in the tacky core layer. This peak can be attributed to N—H bending and C—N stretching, which are unique characteristics of urethane resin. All other peaks are attributed to the acrylic resin. It can be concluded that the surface layer consists of urethane acrylate and that the layers are crosslinked together.

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

1. A multi-layer thermally conductive sheet comprising:
a cured multi-layer curable construction, the curable construction comprising:
a core layer which is tacky upon curing comprising:
at least two (meth)acrylate monomers, a first (meth)acrylate monomer with a number average molecular weight greater than 200 grams/mole and a second (meth)acrylate monomer;
at least one crosslinking monomer;
at least one initiator; and
thermally conductive filler; and
a surface layer which is non-tacky upon curing comprising:
at least one urethane-acrylate monomer; and
at least one initiator.

2. The multi-layer thermally conductive sheet of claim 1, wherein the core layer which is tacky upon curing further comprises at least one of:
an alkyl (meth)acrylate monomer with a number average molecular weight of less than 200 grams/mole; and
a reinforcing co-polymerizable monomer; and
further comprises a plasticizer.

3. The multi-layer thermally conductive sheet of claim 1, wherein the surface layer which is non-tacky upon curing further comprises at least one of:
at least one alkyl (meth)acrylate monomer; and
at least one flow control agent.

4. The multi-layer thermally conductive sheet of claim 1, wherein the at least one urethane (meth)acrylate monomer contains polyester groups.

5. A multi-layer thermally conductive sheet comprising:
a cured multi-layer curable construction, the curable construction comprising:
a core layer which is tacky upon curing comprising:
at least one (meth)acrylate monomer with a number average molecular weight less than 200 grams/mole;
at least one crosslinking monomer;
at least one initiator;
thermally conductive filler; and
at least one plasticizer; and
a surface layer which is non-tacky upon curing comprising:
at least one urethane-acrylate monomer;
at least one alkyl (meth)acrylate monomer; and
at least one initiator.

6. The multi-layer thermally conductive sheet of claim 5, wherein the core layer which is tacky upon curing further comprises at least one reinforcing co-polymerizable monomer.

7. The multi-layer thermally conductive sheet of claim 5, wherein the core layer which is tacky upon curing comprises 30-90% by weight of thermally conductive filler.

8. A method of preparing a multi-layer thermally conductive sheet comprising:
preparing a first curable composition comprising:
at least one (meth)acrylate monomer;
at least one crosslinking monomer;
at least one initiator;
thermally conductive filler; and
at least one plasticizer;
preparing a second curable composition comprising:
at least one urethane-acrylate monomer;
at least one alkyl (meth)acrylate monomer; and
at least one initiator;
providing a first carrier layer;
providing a second carrier layer;
contacting the second curable composition to the second carrier layer to form a second curable layer with a thickness of from 0.01-0.10 millimeters;
contacting the first curable composition to the first carrier layer to form a first curable layer with a thickness of from 0.2-10.0 millimeters;
contacting the second curable layer to the first curable layer; and
simultaneously cure the first curable layer and the second curable layer to form a multi-layer thermally conductive sheet with a first cured layer that is tacky and a second cured layer that is non-tacky.

9. The method of claim 8, wherein the first curable composition comprises:
at least two (meth)acrylate monomers, a first (meth)acrylate monomer with a number average molecular weight greater than 200 grams/mole and a second (meth)acrylate monomer;
at least one crosslinking monomer;
at least one initiator;
thermally conductive filler; and
at least one plasticizer.

10. An article comprising:
a battery module with an exterior surface;
the multi-layer thermally conductive sheet of claim 1 having a first surface and a second surface, the surface layer comprising the first surface,
wherein the first surface of the multi-layer thermally conductive sheet is in contact with at least a portion of the exterior surface of the battery module; and
a metallic part with an exterior surface, where at least a portion of the exterior surface of the metallic part is in contact with the second surface of the thermally conductive sheet;
wherein the second surface of the multi-layer thermally conductive sheet is a tacky surface and the first surface of the multi-layer thermally conductive sheet is a non-tacky surface.

11. An article comprising:
a battery module with an exterior surface;
the multi-layer thermally conductive sheet of claim 5 having a first surface and a second surface, the surface layer comprising the first surface,
wherein the first surface of the multi-layer thermally conductive sheet is in contact with at least a portion of the exterior surface of the battery module; and
a metallic part with an exterior surface, where at least a portion of the exterior surface of the metallic part is in contact with the second surface of the thermally conductive sheet;
wherein the second surface of the multi-layer thermally conductive sheet is a tacky surface and the first surface of the multi-layer thermally conductive sheet is a non-tacky surface.
